(19) United States
(12) Patent Application Publication
(10) Pub. No.: US 2016/0125518 A1
(43) Pub. Date: May 5, 2016

(54) PROCESS, SYSTEM AND COMPUTER PROGRAM PRODUCT FOR ASSET MAINTENANCE

(71) Applicant: SNECMA, Paris (FR)

(72) Inventors: Celia DOOM, Noisy Sur Ecole (FR); Samuel LEROUGE, Montrouge (FR); Salomon SERFATY, St Maur Des Fosses (FR)

(73) Assignee: SNECMA, Paris (FR)

(21) Appl. No.: 14/897,950

(22) PCT Filed: Jun. 13, 2014
(86) PCT No.: PCT/IB2014/002117

§ 371 Date: Dec. 11, 2015

Related U.S. Application Data
(60) Provisional application No. 61/835,345, filed on Jun. 14, 2013.

(51) Int. Cl. G06Q 30/06; G06Q 10/00; G06Q 20/10

(52) U.S. Cl. CPC G06Q 30/0645; G06Q 20/10; G06Q 10/20

(57) ABSTRACT

A process, system and computer program product for asset maintenance, performed by an asset management system which evaluates an expected operational life until maintenance on the asset is no longer economical, and determines a frequency and a scope of maintenance work for each asset over the expected remaining life of each asset, determines a cost of maintenance over the expected remaining life of each asset based on the frequency and scope of the maintenance work and operational factors, establishes a first maintenance agreement between an asset maintenance company and an asset owner, and a second maintenance agreement between the asset maintenance company and operator such that the maintenance agreements include the frequency, scope, and costs of maintenance work.

### CROSS-REFERENCE TO RELATED APPLICATIONS

This application claims priority to U.S. Application No. 61/835,345, filed on Jun. 14, 2013, the entire content of which is incorporated in the present document by reference.

This application relates to U.S. application Ser. No. 13/403,272 filed on Feb. 23, 2012, the entire content of which is incorporated in the present document by reference.

### BACKGROUND

The current disclosure relates to the field of maintenance of an aerospace asset such as an aircraft or aircraft engine. Commercial airplanes and their engines are operated by airline companies, referred to as Operators, but conventionally belong to financial organizations, referred to as Lessors.

Lessors and Operators enter into rental or lease contracts which may have a duration of 4-7 years during which an Operator leases aircrafts, engines or both engines and aircrafts from one or more Lessors. An engine is conventionally leased by 4 to 5 operating airlines over the course of its life cycle, which is on the order of 20 to 30 years depending on the conditions of use. Regardless of which airline operates an engine, each engine must be maintained and monitored consistently over its entire life cycle.

Maintenance comprises the necessary tasks required to maintain or restore an engine or aircraft for airworthiness. Maintenance requirements may include regulatory requirements, which establish standards regarding repairs and overhauls.

Conventionally, Operators are responsible for scheduling and performing maintenance operations either in-house or by contracting out to a maintenance company (MC). A maintenance company may be an original equipment manufacturer (OEM), or independent maintenance repair and overhaul (MRO) outfits.

A generic maintenance program provides baseline tasks applicable to a fleet of engines or aircrafts. Operators can develop their own maintenance programs around a framework of regulatory requirements, vendor data, past engine performance and other factors. Smaller airlines maintenance programs may not have the knowledge or manpower to adapt a maintenance program for a specific operational use, or it may not be cost-effective for the airlines to do so.

In the prior art, Operators thus enter in a contract with one or more maintenance companies (MCs) to ensure maintenance for a fleet of engines the airline operates, but which may include engines belonging to different Lessors. Maintenance requirements set forth by the Lessors may vary, for instance the engine condition requirements set forth for the delivery of engines to the Operators, and for the re-delivery of engines from the Operator to the Lessor, for example at the end of the lease Maintenance requirements may also vary from one airline to another as a result of different operating conditions, such as route length, number of take-offs, and environmental factors. In addition, each Operator can have specific procedures and requirements for executing care and maintenance, thereby adding to the complexity of maintenance contracts required to cover a fleet of engines throughout their life cycle.

### SUMMARY

A process, system and computer program product for asset maintenance, performed by an asset management system which evaluates an expected operational life until maintenance on the asset is no longer economical, and determines a frequency and a scope of maintenance work for each asset over the expected remaining life of each asset, determines a cost of maintenance over the expected remaining life of each asset based on the frequency and scope of the maintenance work and operational factors, establishes a first maintenance agreement between an asset maintenance company and an asset owner, and a second maintenance agreement between a maintenance company and operator such that the maintenance agreements include the frequency, scope, and costs of maintenance work.

### BRIEF DESCRIPTION OF THE DRAWINGS

The characteristics and advantages of an exemplary embodiment are set out in more detail in the following description, made with reference to the accompanying drawings.

FIG. 1 depicts a non-limiting example of the steps carried out by an engine diagnostic tool;

FIG. 2 depicts a non-limiting example of the inputs and outputs of an engine asset management tool;

FIG. 3 depicts a non-limiting example of the steps carried out by an engine asset management tool;

FIG. 4 depicts a non-limiting example of the hardware of the engine asset diagnostic tool;

FIG. 5 depicts a non-limiting example of the hardware of the engine asset management tool;

FIG. 6 depicts the relationships between Lessor, Operator and Maintenance Company in the prior art;

FIG. 7 depicts a non-limiting example of the relationships between Lessor, Operator and Maintenance Company in an exemplary embodiment; and

FIG. 8 depicts a timeline of when contracts may be established in an exemplary embodiment.

### DETAILED DESCRIPTION OF THE PREFERRED EMBODIMENTS

It is an object and feature of an exemplary embodiment of a process, system and computer program product for asset maintenance to implement a maintenance plan which results in cost saving benefits for Lessors, Operators, and Maintenance Companies.

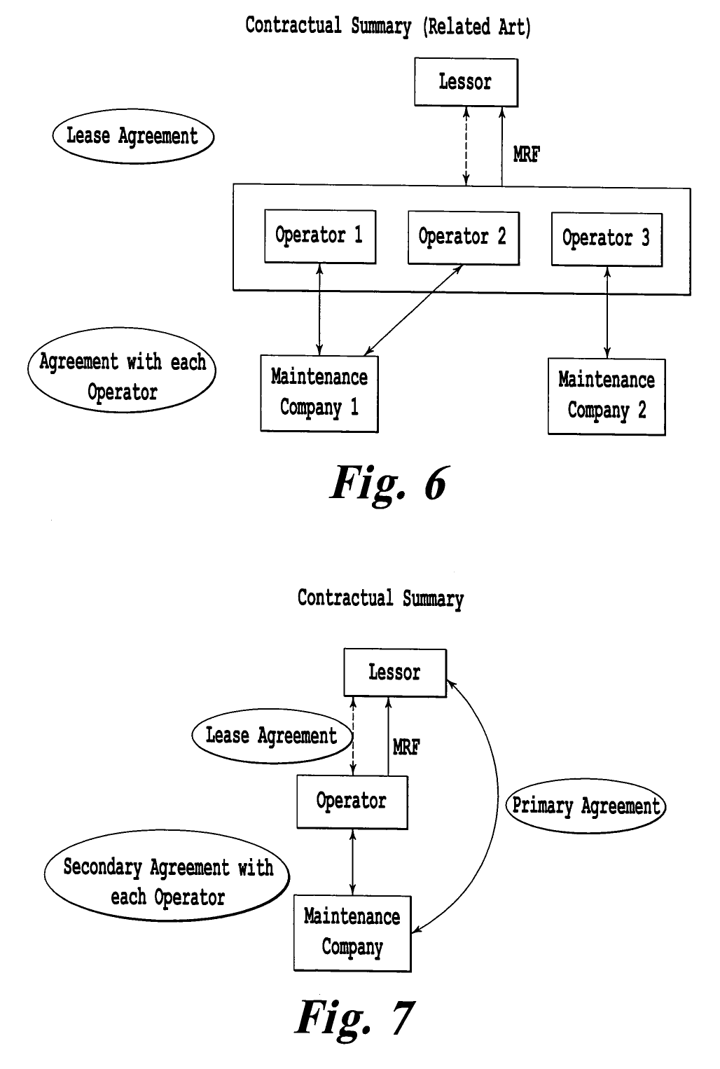

As shown in FIG. 6, in a non-limiting example a lease agreement exists between the Lessor and Operators, while individual maintenance agreements exist between each Operator and a Maintenance Company. As shown in FIG. 6, a maintenance company may be contracted by multiple operators, to perform maintenance on engine fleets with different operators.

The type and frequency of maintenance tasks may be scheduled based on technical safety factors such as hard time requirements, condition based testing, and condition monitoring. For example, a hard requirement may be set that high pressure turbine blades be replaced every 20,000 flight hours, whereas a labyrinth seal may be replaced if periodic checking reveals a clearance below a specified threshold, and temperature in the combustor may be monitored to determine trends and an acceptable range of temperatures before replacing elements of the combustor.

The type and frequency of maintenance tasks may also be based on economic factors. Maintenance must provide safety guarantees at a level acceptable to the regulatory entities, the Operators and Lessors, while avoiding unnecessary costs. Unnecessary costs may be associated with premature replacement of parts, as well as extended time off-wing and reduced operational time.

In a non-limiting example, a maintenance contract between an Airline and a Maintenance Company may be a time and material contract, or a pay per hour contract. For example, the maintenance contract may define the duration of the contract, the scope of the maintenance, scheduling and location of maintenance operations, conditions for material supplies, policies in case of delays, warranty and liability clauses, and pricing. In a non-limiting example, as discussed below, Lessors may require that the Operators deposit funds monthly into a Maintenance Reserve Fund (MRF) owned by Lessors. Once Operators have paid the maintenance companies for maintenance operations, Operators can obtain a refund from the Lessor, provided the airlines can show evidence of maintenance performed. The refund provided by the Lessor is withdrawn from the Maintenance Reserve Fund and is dependent on conditions specific to the lease agreement.

As a result of the complexity of conventional maintenance schemes, there is no portability of a maintenance contract from one airline to another and there remain discontinuities in engine monitoring between airlines. There is no portable maintenance contract allowing the Lessor to enforce maintenance standards throughout engine life, regardless of the operator. Instead, conventional maintenance contracts are Operator specific, and therefore cannot be ported over from one operator to another. To compensate for the maintenance discontinuities associated with Operator changes, additional maintenance requirements may be set forth in the lease agreement, also known as operating lease agreement, between Operator and Lessor to assess engine condition and ensure a safe transition when an engine transitions to a new airline. In a non-limiting example, these end of use and start of use inspections allow the engines' or aircrafts' remaining potential to be assessed.

For example, a first airline may require a part to be replaced every 10,000 flight hours, while a second airline may only require a part be replaced every 15,000 flight hours. Alternatively, a first airline may require a part to be systematically changed every 10,000 flight hours, while a second airline may require the same part to be inspected every 5,000 flight hours, and replaced if needed, which may occur at 20,000 flight hours or 35,000 flight hours. Transitions between Operators therefore include costly inspections, and transitions between maintenance contracts can undermine engine reliability, effectively shorten the lifespan of an engine, and result in a loss of profits for the Lessor, as well as additional expenses for the Operators.

From a valuation perspective, an asset such as an engine or aircraft has a current market value, which is adjusted based on manufacturing context, market conditions, regulatory requirements, and individual use. In a non-limiting example, asset operational life is determined from an economic standpoint as the operational life before the asset is beyond economical repair (BER), i.e. before the cost of necessary maintenance is higher than the remaining value of the asset. In a non-limiting example an asset may be an engine or an aircraft and an estimate of individual use can be based on previous events and remaining life. In a non-limiting example, within an asset group some assets may be categorized as new, while some assets may be characterized as used. Accordingly, in a non-limiting example, used assets may have already undergone performance restoration shop visits, while new assets may not have undergone the same amount or type of maintenance events. In a non-limiting example, depending on the Lessor and the entry age of an engine in a maintenance program, the number of remaining shop visits to be carried out over the course of the maintenance program may vary. In a non-limiting embodiment a maintenance agreement between an operator and a maintenance company may end at substantially as when the operating lease between the operator and the lessor ends. In a non-limiting embodiment, a maintenance agreement between an operator and a maintenance company may terminate either before or after the operating lease agreement between the operator and the lessor is terminated.

For example, engine and aircraft values can depend on the production rates, pricing and performance of equipment manufacturers. In addition, the supply and demand for aircraft and engines is linked to air traffic growth or recession. Regulatory requirements such as airworthiness directives may be country specific.

Maintenance status is a factor in evaluating engine and aircraft value, both from a technical and a financial standpoint. For example, aircraft or engine values may be adjusted to account for high cost maintenance operations such as overhauls or restorations. Aircraft or engine components may have a value which is fully or partially restored following a shop visit. For example, engine life limited parts are replaced before the end of their expected life, and their value is fully restored when replaced by new. In an example, monitoring may lead to a part being restored when it is at 40% of its value, and the shop visit may only restore its value to 80%. Direct maintenance costs may vary with the age of the asset. For new products there may be a learning curve during which fine-tuning takes place and may generate additional costs and inefficiencies. Maintenance costs may then lower and stable during the engine maturity, before rising again towards the end of the parts' lives. In a non-limiting example, after the second performance restoration shop visit a larger number of parts may require testing and replacements, with associated costs greater than the learning curve costs. Engine maintenance status needs to be carefully monitored in order to best forecast aircraft market values.

Maintenance reserves are determined based on predicted maintenance costs. Lessors use maintenance reserves to mitigate risk in the event that a Lessee (Operator) is unable to pay for a maintenance operation. In a non-limiting example, maintenance reserve payments from the Operator to the Lessor may be calculated based on flight hour or cycle, and paid on a monthly basis. Maintenance reserve funds can be specific to a certain component, and can also be non-transferable between components. In a non-limiting example, excess reserves are not reimbursed to the Lessees in the event that major maintenance events require less than the accumulated reserves. PML. In a non-limiting example of the present invention using the Maintenance Reserve Fund, the Operator may deposit dues into the Maintenance Reserve Fund, but may not need to show the Lessor proof of maintenance work performed to be reimbursed. Furthermore, any maintenance work not covered by the funds in the Maintenance Reserve Fund may be identified in an agreement.

Maintenance reserve amounts are generated based on previous maintenance reserves, and published engine or aircraft fleet analysis data. Due to multiple sources of uncertainty it may be both difficult to predict the costs and to distribute costs over monthly payments. Reserve rates also take into consideration costs and intervals at which maintenance events will be performed. Routine maintenance tasks and deviation from expected life are used, as well as one-time costs incurred by the Airlines as a result of unpredicted maintenance events. Maintenance reserves can also be adjusted based on the phase of the maintenance cycle. Man-hours and material costs associated with routine tasks are also typically factored into maintenance reserves. Accidental damage repair such as that resulting from unforeseen engine operations or environmental factors is typically not factored in.

Maintenance costs and maintenance reserve rates can depend on operational factors, part deterioration rates, cost of materials and wages.

Operational factors such as flight length and operating environment may influence maintenance costs. For example, lower flight lengths result in accelerated cyclic loads, and performance deterioration as a result of more frequent take-offs and climbs. Points of origin and destination, as well as the location of storage facilities can impact performance with for example dry and dusty environments leading to part corrosion.

Shop maintenance events comprise performance restoration events which involve dismantling of the engine to inspect and repair them, and critical life limited part (LLP) replacements for components such as disks or shafts which can have a fixed operating life. Life Limited Parts (LLP) are governed by the number of flight hours or flight cycles, and can play a critical role in the safety of asset use. Maximum acceptable lives of LLPs are set differently by different manufacturers.

Costs associated with engine shop maintenance events are largely a result of cost of materials, although wages for maintenance workers of all skills are also subject to inflation. Inflation will vary differently for different maintenance events depending on whether the cost of these maintenance events is labor driven or materials driven.

In a non-limiting example, the Lessee (Operator) pays the Maintenance Company upon completion of the work, and claims a reimbursement from the Lessor out of the accumulated reserve accounts. Reimbursement is only up to the total value of the specific reserve account. In a non-limiting example, cost of work in excess of the maintenance reserve fund is the responsibility of the Lessee, as set forth in the lease agreement.

In a non-limiting example, Maintenance Companies offer agreements for long term services to the Operators, based on costing estimates for maintenance visits. The use of average costing estimates with regard to number of shop visits, parts to be replaced, and associated man hours, can lead to a lack of precision in predicting maintenance costs. Accordingly, Operators and Lessors may experience discrepancies between predicted maintenance costs and actual maintenance costs.

A goal for Lessors is to maximize the time on wing and life time of their engines in order to achieve a low cost of ownership, and to maintain and maximize the asset value which requires consistent monitoring and maintaining of engines throughout their life cycle. A goal for the Operators is to minimize maintenance costs, particularly costs associated with unpredicted maintenance events. A goal for Maintenance Companies is to minimize fixed costs, and to benefit from maintaining a high volume of assets. It is advantageous for maintenance companies to have standard maintenance procedures which can be carried out on one or more fleets of engines, to avoid incurring costs associated with multiple customized maintenance procedures.

As shown in FIG. 7, in an exemplary embodiment of the invention as a product or process for asset maintenance a lease agreement is present between the Lessor and Operator. In an exemplary embodiment, such a lease agreement may include provisions regarding the term of the lease, the amount of the rent to be paid, and the modalities of the payment. In a non-limiting example, the lease may further include information regarding the responsibility of the parties to pay taxes and/or fees incurred. In a non-limiting example, the lease may also include a duty of the Operator to report information to the Lessor, such as reporting damages or fines. In a non-limiting example, the lease may include a description of responsibilities with regard to using and operating the engines, for example ensuring that the Operator abides by standards and regulations such as those set for safety and airworthiness. In a non-limiting example, the lease may further include some maintenance provisions, such as requiring that engines be maintained at a level such that they remain in service. Furthermore, in a non-limiting example, the lease can detail insurance provisions in the event that damages occur, such as from unforeseen naturally causes. Return provisions including return inspection requirements and consequences in the event of a failure to return an engine may also be specified in a non-limiting example of the lease agreement. General default situations, early terminations, early purchase or lease extension options may be addressed by the lease, in a non-limiting example.

As shown in FIG. 7, in an exemplary embodiment of the invention as a product or process for asset maintenance a primary maintenance agreement may exist directly between a Maintenance Company and a Lessor. This primary agreement may define maintenance operations on an engine fleet for which the Lessor holds a title or is a beneficial owner, regardless of which airlines operate engines within the fleet. In an exemplary embodiment of the product for asset maintenance there may also be a secondary contract between the Maintenance Company and one or more participating airlines. This secondary agreement (C20) may offer a wide range of customizable maintenance services to the Operator. In an exemplary embodiment of the product for asset maintenance the lease agreement, primary and secondary agreements must be adapted to each other. For example, the lease agreement may be adjusted to account for engine exit conditions which result from the maintenance agreements.

One advantage of an exemplary embodiment of the invention as a product or process for asset maintenance is consistent maintenance and monitoring of engines. Another advantage of an exemplary embodiment of the invention as a product or process for asset maintenance is a portable agreement which allows maintenance services and prices to be ported from one airline to another. Yet another advantage of an exemplary embodiment of the invention as a product or process for asset maintenance is that consistent maintenance and portability still allow airlines flexibility in signing a maintenance agreement with a maintenance company to enter a maintenance program. Upon signing a maintenance agreement, Operators may have control over work scope validation and may request additional maintenance work. Another advantage of an exemplary embodiment of the invention as a product or process for asset maintenance is increased maintenance reliability and reduced costs for Lessors, Operators and Maintenance Companies.

In an exemplary embodiment of the invention as a product or process for asset maintenance, Maintenance Companies may benefit from maintaining a larger engine fleet by gathering data over a larger data set, which provides more reliable engine statistics. By having a number of assets greater than the threshold amount required for the asset population to be statistically representative, in other words by reaching a critical statistical level engine data statistics and the simulations based on the engine data statistics are more reliable, providing better estimates for time on wing and cost predictions. Operators may benefit from a high volume effect, for example smaller operators which may benefit from the competitive pricing resulting from the Maintenance Company's high asset volume which leads to competitive pricing. Conventional maintenance agreements drive inefficiencies in outsourcing, tooling, labor and parts for the Maintenance Operators. In an exemplary embodiment of the invention as a product or process for asset maintenance, operator specific maintenance operations may be optimally planned, in addition to the standardized Lessor-driven maintenance operations. In an exemplary embodiment of the invention as a product or process for asset maintenance, Lessors may benefit from a stronger control over maintenance quality, and optimized asset lives. In an exemplary embodiment of the invention as a product or process for asset maintenance, Operators may benefit from the competitive pricing and a more extensive coverage for unexpected maintenance events, while Maintenance Companies can benefit from a reduction in risk and variability with a large number of assets and shop visits.

These and other objects, advantages, and features of the invention as a product or process for asset maintenance described herein will be apparent to one skilled in the art from a consideration of this specification, including the attached drawings.

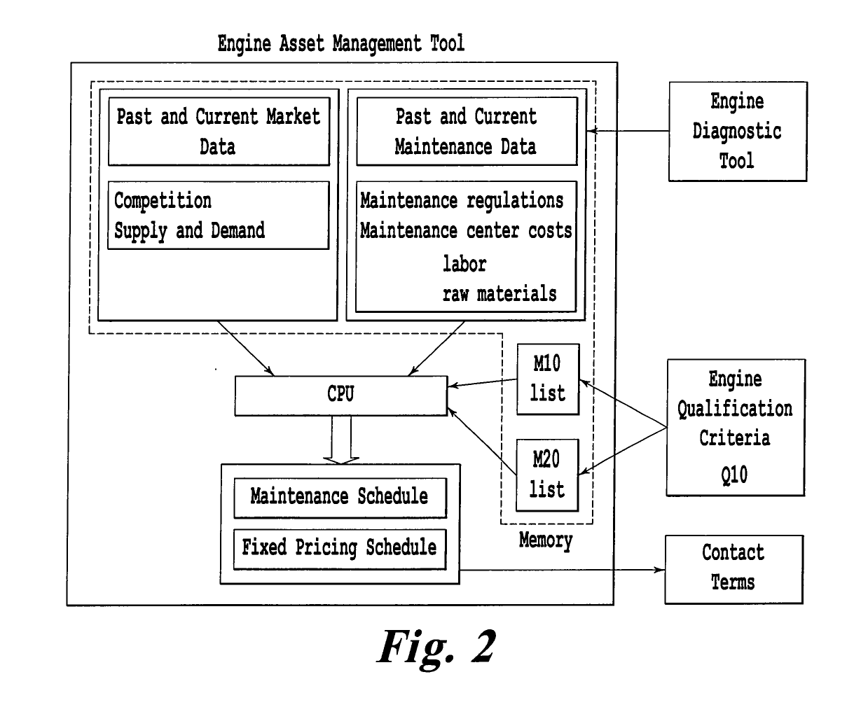

In an exemplary embodiment of the present invention, in order to set the maintenance schedule and fixed pricing scheme which may be integrated into agreements C10 and/or C20, an engine qualification process for eligible or active status may involve a document review with regards to previous maintenance carried out on the engine, yielding asset lists M10 and M20 which can be used by the engine asset management tool, as shown in FIG. 2.

In an exemplary embodiment of the present invention, a pricing scheme can include pricing for major and minor events, where major events, such as performance restoration shop visits, may be priced with a fixed price per flight hour, to be paid by the Operators monthly to the Lessor's Maintenance Reserve Fund, and used by the Lessor to pay the Maintenance Company. In this exemplary embodiment the Lessor may pay the Maintenance Company at the time of each shop visit. For minor events, Operators may elect to pay either on a price per flight hour basis or on a time and material basis. For minor events paid monthly, Operators may pay the fixed price per flight hour times the number of flight hours operated during the month. In a non-limiting embodiment the maintenance cost per flight hour is fixed over the duration of the maintenance agreement, except for a yearly adjustment related to inflation, with a maximum annual escalation. In a non-limiting embodiment, the maintenance costs, maximum annual escalation, and modalities of payment (per flight hour, per event, or per time and material) may be set forth in the main C10 agreement between Lessor and Maintenance Company, the secondary C20 agreement between Maintenance Company and Operator, and in the lease agreement between Lessor and Operator.

In an exemplary embodiment of the present invention, the use of the Maintenance Reserve Fund kept by the Lessor mitigates risks for the Lessor, with no impact for the Maintenance Company.

In order to determine the work scope of the required maintenance a failure model is used, with the model defined as a function of engine parameters, and refined by applying maintenance decision rules. However, for an engine operating in humid climates, the model may be modified to account for earlier turbine corrosion blade damage, and the work scope of a maintenance operation adjusted accordingly. As such, engine specificities based on engine data may be taken into account to determine a particular scope of work, instead of an average scope of work.

In an exemplary embodiment of the present invention, an engine asset diagnostic tool gathers engine data daily for multiple engines, and may be used by Operators and Maintenance Companies to assess engine performance and engine life, and maintenance needs. For example, Operators can monitor the health of each engine, i.e. track in real-time the status of each engine, and Maintenance Companies can derive trends for properties such as pressure and temperature at different stations within each engine. In addition, in a non-limiting example Lessors may have access to the health monitoring information. In a non-limiting example, data gathered may include engine type, the state of the engine, the number of flight hours on the engine, utilization conditions of the engine, and the volume or frequency of maintenance events on the engine.

The engine asset diagnostic tool may comprise a processing circuit to carry out the steps of data collection and data analysis from multiple engines remotely or directly, and data transmission, and a memory to store the gathered data.

In an exemplary embodiment, in addition to the engine asset diagnostic tool collecting engine data, stored qualification criteria Q10 may be used to output a list of engines M10 meeting the eligibility requirements under the main agreement C10. A qualification process may weigh qualification criteria differently for each engine, depending on the data collected for the engine.

In an exemplary embodiment, in addition to collecting engine data the engine diagnostic tool may collect or directly receive input data for the airlines operating the engines.

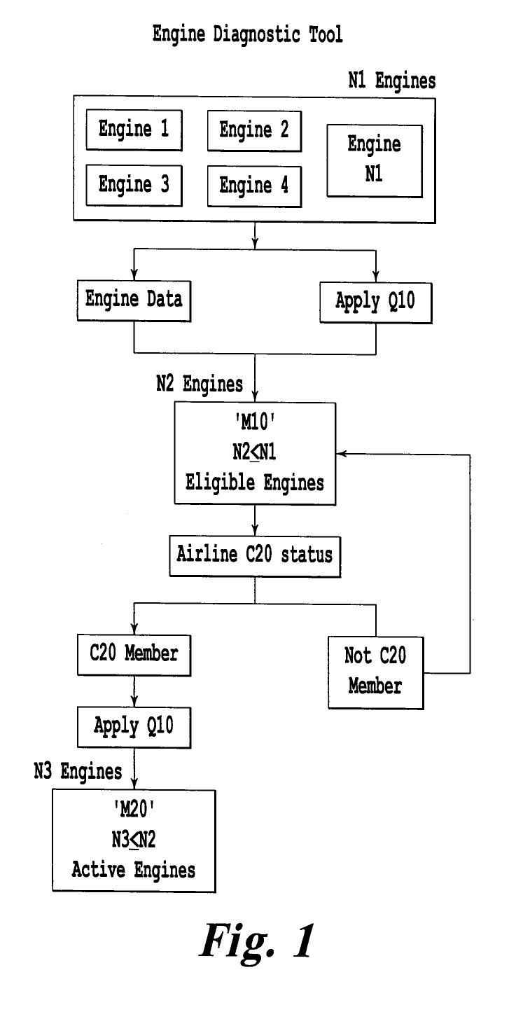

In an exemplary embodiment, as shown in FIG. 1, a list of eligible engines M10 stored qualification criteria Q10 and input data on the airline participation in the secondary agreement may be used in combination with the engine asset management tool to output a list of engines M20 meeting the active status requirements under the secondary agreement C20. In an exemplary embodiment, based on previous engine maintenance information a database of eligible engines M10 may be obtained, and for airlines participating in C20, a database of active engines M20 may be transmitted to be used as input by an engine asset management tool described below.

In an exemplary embodiment of the present invention, an engine asset management tool may comprise a memory to store data, and a processing circuit to carry out the steps of receiving inputs from the engine diagnostic tool, accessing stored data, weighing stored data and input data, interpolating data over time to provide future estimates of optimized maintenance costs and an optimized maintenance schedule, which may be incorporated in at least one of the agreements C10 and C20.

Engine data collected from one or more fleets of engines can provide information on past failures such as the type of shop visits for past failures, operating environment and operational condition of engines, and maintenance facilities. In addition, relevant engine parameters can include the age of the engine, the engine technical history measured in operating hours or cycles since the last shop visit, the number of shop visits performed, and the potential remaining life for each of a plurality of life limited parts (LLP). In a non-limiting example pre-determined operation-pricing tables may be used to define and adjust an average cost per flight hour based on the severity of engine operating conditions, as described in a maintenance agreement between the Lessor and Maintenance Company, or an agreement between a Maintenance Company and an Operator.

In an exemplary embodiment, as shown in FIG. 2, the engine asset management tool may additionally store maintenance data and market data. Maintenance data may include for example different maintenance center costs, such as cost of raw materials and cost of labor in the countries where the maintenance centers may be located. In a non-limiting example market data may include expected supply and demand in parts and raw materials, or fleet replacement time estimates. The engine management tool must weigh at least the above-noted factors, and estimate their predicted evolution based on an agreement length.

In an exemplary embodiment, the engine asset management tool may output a maintenance schedule for the selected engines, and a pricing scheme for the Lessors, which may be include a pricing scheme per flight hour for some events, and a pricing scheme per flight hour or per event for other events. In a simplified non-limiting example the pricing scheme may be computed by adding for each engine the expected maintenance cost over the duration of the maintenance contract between Lessor and Maintenance Company, where the expected maintenance cost may be computed per maintenance event, per engine flight hour, or with a combination of both.

Accurately predicting the evolution of a large number of variable sets over for example a 20 year span, may require for example the use of random walk hypotheses and the determination of non-linear correlations or genetic algorithms which may be stochastic in nature to update weights of the different parameters being used.

Engine data is used to generate statistical failure models for various engines, providing information regarding the cumulated probability of failure as a function of the number of hours on wing. Statistical failure models may use Weibull distributions, which are suitable for modeling the life of an engine, and capable of reproducing the behavior of other probability laws.

Monte Carlo simulations can then be used on failure models and engine monitoring data to obtain the most probable failure model for an engine, and predict the age of an engine at failure. Monte Carlo simulations use stochastic inputs to provide a deterministic output from stochastic inputs, such that from a number of occurrences of a failure event a probability of occurrence of the event can be obtained.

Decision rules may be applied to the most probable failure model obtained from the Monte Carlo simulations to determine the scope of work. Thus, the most realistic scope of work can be planned to occur when the most probable engine failure is predicted.

Furthermore, for each failure model and associated failure time or shop visit schedule, a first set of rules can comprise critical under-wing times which define operational ranges corresponding to different scopes of work. In other words, scope of work for each engine type can be adjusted relative to engine operating times. In addition, for each operational range obtained from the first set of rules, a second set of rules can be used to further define the scope of work by including reconstruction constraints.

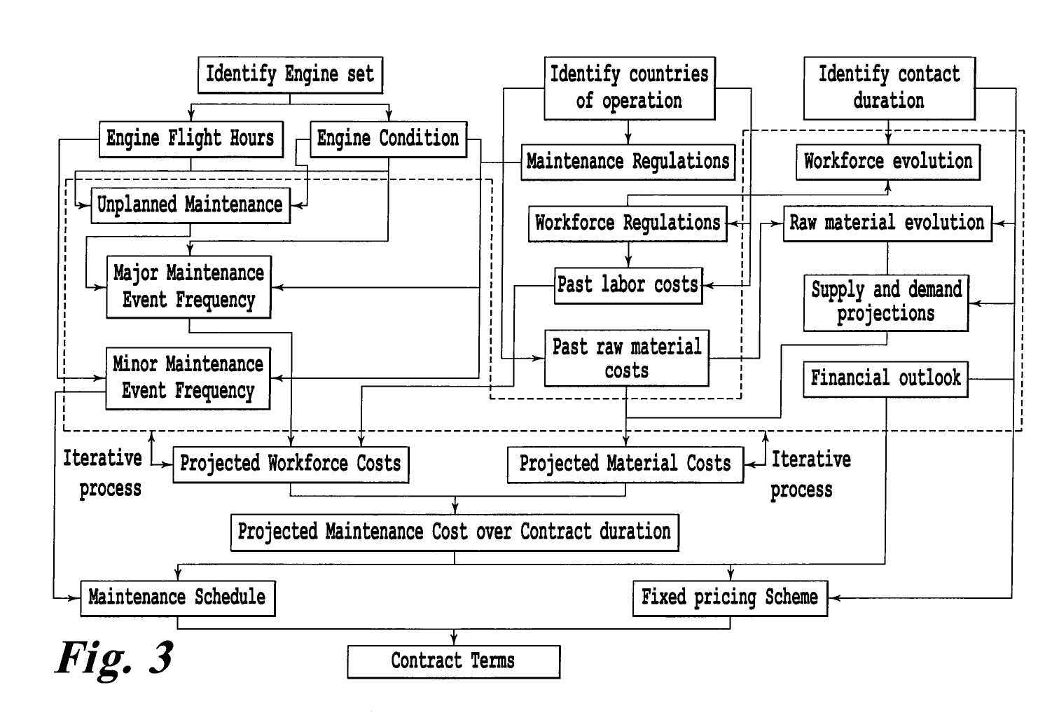

In addition, the engine asset management tool may identify an engine set such as M10 or M20, together with the countries of operation for the engines, and a desired agreement duration, whether for a C20 agreement, or for a C10 agreement. In a non-limiting example the duration of the contract C10 may be the expected life of the engine, at least 10 years, preferably at least 15 or 20 years, and the duration of the contract C20 may have a duration equal to the duration of a lease agreement. In an exemplary embodiment, the duration of C20 may be between 1 and 8 years or 3 to 5 years. In a non-limiting example for each country of operation, the engine asset management tool may gather data such as engine maintenance regulations, workforce regulations, as well as past labor and raw material costs. In a non-limiting example, based on the desired agreement duration, trends may be obtained regarding the workforce and raw material evolutions in size and pricing, together with supply and demand projections, and financial outlook estimates based on market trends. In the non-limiting example of FIG. 3, data collected and estimations made may be used to predict workforce and material costs over the agreement duration.

In a non-limiting embodiment, as shown in FIG. 3, based on the scope of work calculations, an iterative-type process may then be applied between the projected workforce costs and the various engine-related projections, and market-related projections, to converge towards an accurate projected workforce cost. Similarly, in a non-limiting example, an iterative-type process may then be applied between the projected material costs and the various engine-related projections, and market-related projections, to converge towards an accurate projected materials cost. A total projected maintenance cost may then be established for the selected agreement duration, which may be used to determine a maintenance schedule and fixed pricing scheme by the Maintenance Companies, for the Lessors. Lessors can then set the Maintenance Reserve Fund value accordingly.

In a non-limiting embodiment of the invention as a product or process for asset maintenance the number of unscheduled maintenance events and the extent of maintenance events associated with entry and exit from a leasing agreement are reduced.

Conventionally, the leasing agreement between Lessor and Operator (Airline) includes maintenance conditions and pricing for restituting an engine to the Lessor. In a non-limiting example, conventional restitution conditions may require that an engine be restituted with at least 7000 hours of life remaining on wing, and stipulate a monetary fine if the Airline has not restored the engine to the required remaining life through maintenance operations. Conventional restitution policies generally hold Airlines to a much higher maintenance standard than is required by safety regulations alone. As a result of a non-limiting embodiment of the invention as a product or process for asset maintenance, Lessors may impose easier restitution conditions. For example, in a non-limiting example of the invention, Lessors may only require that the engine have 2000 hours remaining on wing. One advantage for the Operator is the reduction of restitution costs associated with engine restitution maintenance. Accordingly, a non-limiting embodiment of the invention as a product or process for asset maintenance reduces the cost per flight hour of an engine over its lifespan for an Operator. A non-limiting embodiment of the invention as a product or process for asset maintenance retains the Maintenance Reserve Fund system to mitigate risk for both Lessors and Operators.

In a non-limiting example, the maintenance contract (C20) between the Maintenance Company and an Airline, also referred to as Operator, covers engines which are already subject to a lease agreement between a Lessor and an Operator, whether the engine is a new engine, a first-run engine, or a used engine. In a non-limiting example, a new engine may be defined as an engine which has not been flown, i.e. with zero flight hours. In a non-limiting example, a first-run engine may be defined as an engine which has not had a major shop visit, while a used engine may be defined as an engine which has undergone at least one major shop visit.

In a non-limiting example, for first-run engines already leased by an operator, upon entering the maintenance contract (C20) a price P0 is set, based on the number of hours the engine has flown, and the hourly rates previously defined in a contract (C10) between the Lessor and Maintenance Company. In a non-limiting example, the hourly rates set by the C10 agreement are determined from models based on overall engine life, such that when an engine enters coverage under the C20 agreement, the P0 price provides the Maintenance Company with the necessary funds to cover the actual engine wear, and contribute to funds used for maintenance events.

For used engines under an existing lease agreement, the P0 price is based on the number of hours flown by the engine since the major shop visit. In a non-limiting example, an engine with 3000 flight hours since new, which underwent a shop visit at 2000 flight hours, may have a P0 price of 3000−2000=1000 times the hourly rate set by the C10 maintenance contract.

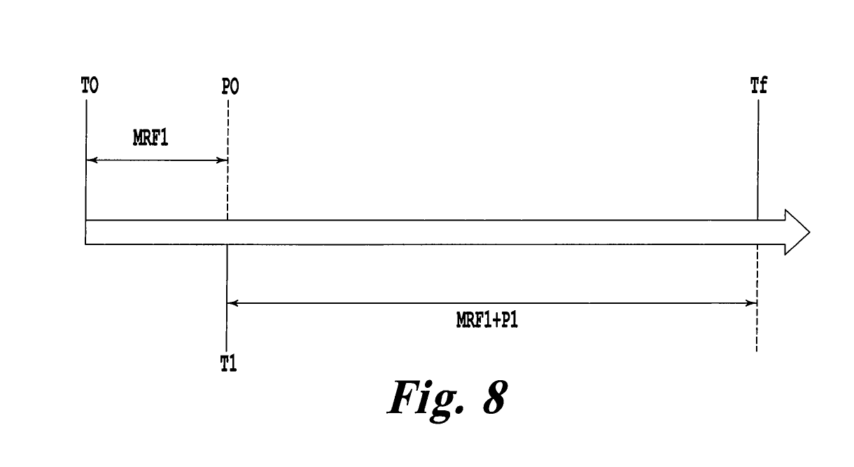

In a non-limiting example, as shown in FIG. 8, from a time T0 at which a lease contract begins between a lessor and a company, the Operator pays the maintenance reserves MRF1 to the lessor to cover major shop events.

When a maintenance contract C20 is established between the Maintenance Company and the Operator at a time T1, the Lessor makes an initial payment P0 which compensates the Maintenance Company for the wear on the engine over the T0 to T1 period. In an exemplary embodiment, the Lessor may draw from the maintenance reserve fund it collected over the T0 to T1 period to make the initial payment P0 to the Maintenance Company.

In addition, from T1 on, the airline company, also referred to as Operator, pays the initial amount of maintenance reserves MRF1, together with an additional maintenance reserve amount P1. In a non-limiting example, the additional maintenance reserve amount P1 may account for additional maintenance coverage provided by the C20 agreement.

In an alternative embodiment, the C20 contract may also cover engines with more than one major shop visit.

In a non-limiting example, a Lessor can adapt the amount of the MRF payments to be made by the Operator, in order to convince Operators to enter into a non-limiting example of the current invention. In a non-limiting example, a Lessor may have peace of mind regarding the tracking, health monitoring, and maintenance costs of its engines. In a non-limiting example, the established fee structure may appeal to an Operator as it significantly reduces the risk of potential budget overruns. In a non-limiting embodiment, a Lessor may gain a competitive advantage with respect to other Lessors by offering a C20 type of agreement to Operators, and in a non-limiting embodiment by also adjusting the MRF1 price. In an exemplary embodiment, the Lessor and/or the Operator may pay the additional amount P1.

In a non-limiting embodiment of the invention for maintaining an asset, the lessor may legally own the asset, and lease the asset, where ownership may further be defined and assigned reversibly within the lease agreement. In a non-limiting embodiment of the invention for maintaining an asset, ownership of the asset by the lessor may be complete dominion of the lessor over the asset. In a non-limiting embodiment of the invention for maintaining an asset, the lessor can have ownership of the asset if it has complete dominion over the asset. In a non-limiting embodiment of the invention for maintaining an asset, the lessor and owner of the asset sustains the loss of the asset at the end of the asset's life, or in case the asset is prematurely destroyed. In a non-limiting embodiment of the invention for maintaining an asset, an ownership interest may include sub-leasing.

In a non-limiting embodiment of the invention for maintaining an asset, a lessor may be identified by inputting the lessor information such as name and address into a database stored on a computer-readable storage media, or accessing a lessor's information from a database on a computer-readable storage media. In a non-limiting embodiment of the invention for maintaining an asset, means for identifying may be at least one of a processing circuit, or a database on a computer-readable storage media. In a non-limiting embodiment of the invention for maintaining an asset, a lessor may also be identified by receiving the lessor information remotely over a network. In a non-limiting embodiment of the invention for maintaining an asset, a lessor may be identified based on the basis of its ownership interest in the asset. In a non-limiting embodiment of the invention for maintaining an asset, an ownership interest may be at least one of the following: ownership, a share in a company which owns an asset, a license for the asset.

In a non-limiting embodiment of the invention for maintaining an asset, a lease interest may be defined by at least one of the following: signing of a lease agreement, ownership of a share in a company which leases an asset, or use of a license for the asset.

In a non-limiting embodiment of the invention for maintaining an asset, a maintenance interest may be at least one of the following: a share in a company which maintains an asset, a license to maintain an asset, or a contract to carry out maintenance on an asset.

In a non-limiting embodiment of the invention for maintaining an asset, means for identifying an entity such as a maintenance company may include inputting the maintenance company information such as name and address into a database stored on a computer-readable storage media, or accessing a maintenance company's information from a database on a computer-readable storage media. In a non-limiting embodiment of the invention for maintaining an asset, a maintenance company may also be identified by receiving the maintenance company information remotely over a network.

In a non-limiting embodiment of the invention for maintaining an asset, means for initiating an agreement may be at least one of a processing circuit, or a database on a computer-readable storage media. In a non-limiting embodiment of the invention for maintaining an asset, means for terminating an agreement may be at least one of a processing circuit, or a database on a computer-readable storage media.

In a non-limiting embodiment of the invention for maintaining an asset, a maintenance reserve fund can be owned by the Lessor, or beneficially run by the Lessor, or owned or beneficially run by a company with an ownership interest in the asset. A maintenance reserve fund may include multiple maintenance reserve funds to be used by separate operators, or multiple maintenance reserve funds for a single operator.

A non-limiting embodiment of the invention is a non-transitory computer readable medium having stored thereon a program that when executed by a computer causes the computer to execute a processor-implemented process for maintaining an asset, wherein the asset is (i) owned by a lessor, (ii) maintained by a maintenance company and (iii) operated by an operator, the system including mean for identifying, in a processor of the computer, the lessor, means for identifying, in a processor of the computer, at least one asset in which the lessor has an ownership interest, means for identifying, in a processor of the computer, the maintenance company which has a maintenance interest in the asset, and means for identifying, in a processor of the computer, a first operator which has a lease interest in the asset, means for initiating a first maintenance agreement (C10) between the maintenance company and the lessor, wherein the first maintenance agreement has a duration, an initiation day and a termination day, means for initiating a first operating lease agreement between the lessor and the first operator, wherein the first operating agreement has a duration, means for terminating the first operating lease agreement, and means for initiating a second operating lease agreement between the lessor and a second operator after determining the status of the asset in a processor of the computer, wherein the second operating lease agreement has a duration, an initiation day and a termination day, wherein, during the duration of the first operating agreement and after terminating the first operating agreement, the first maintenance agreement remains in effect between the lessor and the maintenance company, and wherein during the duration of the first operating lease agreement the first operator transfers funds into a maintenance reserve fund, and during the duration of the second operating lease agreement the second operator deposits funds into a maintenance reserve during the duration of the second operating lease agreement.

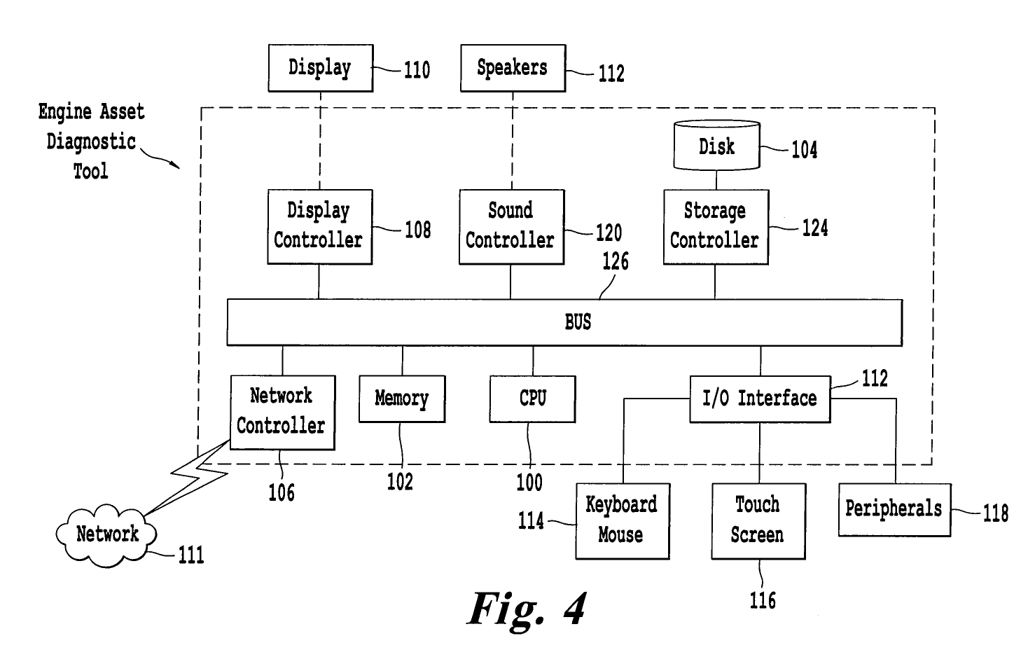

Next, a hardware description of the engine diagnostic tool according to exemplary embodiments is described with reference to FIG. 4. In FIG. 4, the engine diagnostic tool may include a CPU 100 which performs the processes described above. The process data and instructions may be stored in memory 102. These processes and instructions may also be stored on a storage medium disk 104 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the engine diagnostic tool communicates, such as a server or computer.

Further, the claimed advancements may be provided as a utility application, background daemon, or component of an operating system, or combination thereof, executing in conjunction with CPU 100 and an operating system such as Microsoft Windows 7, UNIX, Solaris, LINUX, Apple MAC-OS and other systems known to those skilled in the art.

CPU 100 may be a Xenon or Core processing circuit from Intel of America or an Opteron processing circuit from AMD of America, or may be other processing circuit types that would be recognized by one of ordinary skill in the art. Alternatively, the CPU 100 may be implemented on an FPGA, ASIC, PLD or using discrete logic circuits, as one of ordinary skill in the art would recognize. Further, CPU 100 may be implemented as multiple processing circuits cooperatively working in parallel to perform the instructions of the inventive processes described above.

The engine diagnostic tool in FIG. 4 may also include a network controller 106, such as an Intel Ethernet PRO network interface card from Intel Corporation of America, for interfacing with network 111. As can be appreciated, the network 111 can be a public network, such as the Internet, or a private network such as an LAN or WAN network, or any combination thereof and can also include PSTN or ISDN sub-networks. The network 111 can also be wired, such as an Ethernet network, or can be wireless such as a cellular network including EDGE, 3G and 4G wireless cellular systems. The wireless network can also be WiFi, Bluetooth, or any other wireless form of communication that is known.

The engine diagnostic tool may further include a display controller 108, such as a NVIDIA GeForce GTX or Quadro graphics adaptor from NVIDIA Corporation of America for interfacing with display 110, such as a Hewlett Packard HPL2445w LCD monitor. A general purpose I/O interface 112 may interface with a keyboard and/or mouse 114 as well as a touch screen panel 116 on or separate from display 110. General purpose I/O interface may also connect to a variety of peripherals 118 including printers and scanners, such as an OfficeJet or DeskJet from Hewlett Packard.

The general purpose storage controller 124 may connect the storage medium disk 104 with communication bus 126, which may be an ISA, EISA, VESA, PCI, or similar, for interconnecting all of the components of the diagnostic tool. A description of the general features and functionality of the display 110, keyboard and/or mouse 114, as well as the display controller 108, storage controller 124, network controller 106, sound controller 120, and general purpose I/O interface 112 is omitted herein for brevity as these features are known.

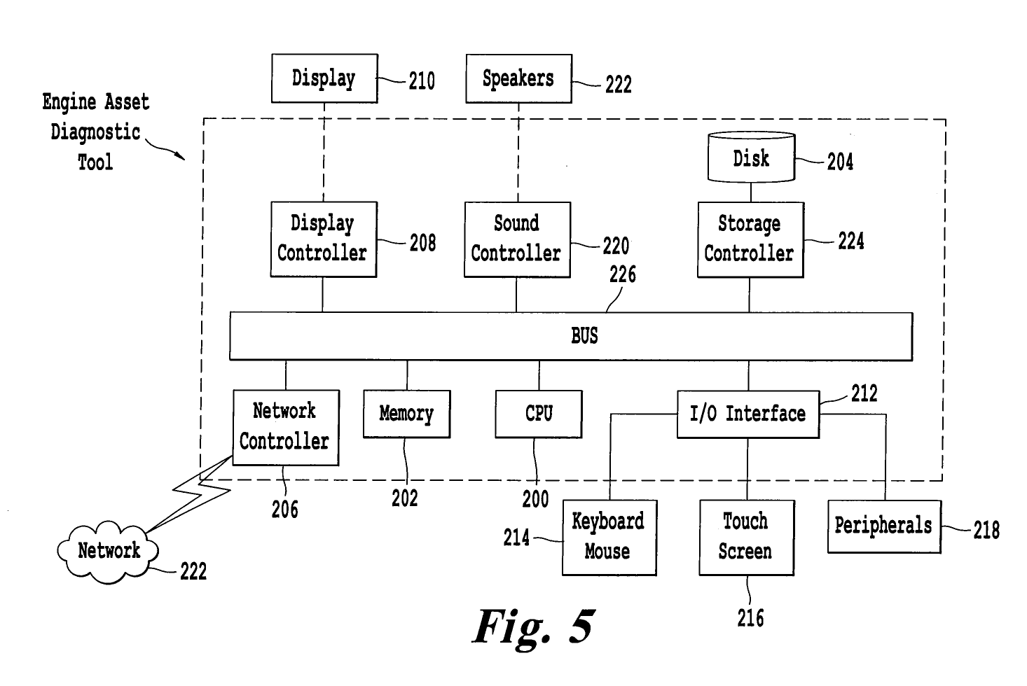

Next, a hardware description of the engine asset management tool according to exemplary embodiments is described with reference to FIG. 5. In FIG. 5, the engine asset management tool may include a CPU 200 which performs the processes described above. The process data and instructions may be stored in memory 202. These processes and instructions may also be stored on a storage medium disk 204 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the engine asset management tool communicates, such as a server or computer.

Further, the claimed advancements may be provided as a utility application, background daemon, or component of an operating system, or combination thereof, executing in conjunction with CPU 200 and an operating system such as Microsoft Windows 7, UNIX, Solaris, LINUX, Apple MAC-OS and other systems known to those skilled in the art.

CPU 200 may be a Xenon or Core processing circuit from Intel of America or an Opteron processing circuit from AMD of America, or may be other processing circuit types that would be recognized by one of ordinary skill in the art. Alternatively, the CPU 200 may be implemented on an FPGA, ASIC, PLD or using discrete logic circuits, as one of ordinary skill in the art would recognize. Further, CPU 200 may be implemented as multiple processing circuits cooperatively working in parallel to perform the instructions of the inventive processes described above.

The engine asset management tool in FIG. 5 may also include a network controller 206, such as an Intel Ethernet PRO network interface card from Intel Corporation of America, for interfacing with network 222. As can be appreciated, the network 222 can be a public network, such as the Internet, or a private network such as an LAN or WAN network, or any combination thereof and can also include PSTN or ISDN sub-networks. The network 222 can also be wired, such as an Ethernet network, or can be wireless such as a cellular network including EDGE, 3G and 4G wireless cellular systems. The wireless network can also be WiFi, Bluetooth, or any other wireless form of communication that is known.

The engine asset management tool may further include a display controller 208, such as a NVIDIA GeForce GTX or Quadro graphics adaptor from NVIDIA Corporation of America for interfacing with display 210, such as a Hewlett Packard HPL2445w LCD monitor. A general purpose I/O interface 212 interfaces with a keyboard and/or mouse 214 as well as a touch screen panel 216 on or separate from display 210. General purpose I/O interface may also connect to a variety of peripherals 218 including printers and scanners, such as an OfficeJet or DeskJet from Hewlett Packard.

The general purpose storage controller 224 may connect the storage medium disk 204 with communication bus 226, which may be an ISA, EISA, VESA, PCI, or similar, for interconnecting all of the components of the engine asset management tool. A description of the general features and functionality of the display 210, keyboard and/or mouse 214, as well as the display controller 208, storage controller 224, network controller 206, sound controller 220, and general purpose I/O interface 212 is omitted herein for brevity as these features are known.

Because many possible embodiments may be made of the invention without departing from the scope thereof, it is to be understood that all matter herein set forth or shown in the accompanying drawings is to be interpreted as illustrative and not in a limiting sense.

1: A process for maintaining an asset, wherein the asset is (i) owned by a lessor, (ii) maintained by a maintenance company and (iii) operated by an operator, comprising:
identifying the lessor,
identifying at least one asset in which the lessor has an ownership interest,
identifying the maintenance company which has a maintenance interest in the at least one asset, and
identifying a first operator which has a lease interest in the at least one asset,
initiating a first operating lease agreement between the lessor and the first operator, wherein the first operating lease agreement has a first operating duration, an initiation day and a termination day,
wherein no later than on a transition day after the initiation day of the first operating lease agreement, the lessor and the maintenance company enter into a first maintenance agreement,
wherein on the transition day the operator signs a second maintenance agreement with the maintenance company,
wherein between the initiation day of the first operating lease and the termination day of the first operating lease the first operator transfers funds MRF1 into a first maintenance reserve fund, and
wherein between the transition day and the termination day of the first operating lease the first operator transfers additional funds P1 into a second maintenance reserve fund.

2: The process as in claim 1, wherein the lessor pays a fixed amount P0 to the maintenance company on the transition day.

3: The process as in claim 1, further comprising on the termination day of the first lease agreement: terminating the second maintenance agreement between the operator and the maintenance company.

4: The process as in claim 1, further comprising after the termination day of the first lease agreement: initiating a second operating lease agreement between the lessor and a second operator.

5: The process as in claim 4, wherein the second lease agreement has a second operating duration, an initiation day and a termination day,
wherein after terminating the first lease agreement, and during the duration of second lease agreement, the first maintenance agreement remains in effect between the lessor and the maintenance company, and
wherein during the duration of the second operating lease agreement the second operator transfers funds into the maintenance reserve fund.

6: The process of claim 3, which further includes:
initiating a third maintenance agreement between the maintenance company and the second operator, wherein the third maintenance agreement has a duration, an initiation day and a termination day, wherein a duration of the third maintenance agreement is equal to the duration of the second operating lease agreement between the lessor and the second operator

7: The process of claim 6, which further includes:
initiating a fourth maintenance agreement between the maintenance company and a third operator,
wherein the fourth maintenance agreement has a duration, an initiation day and a termination day, wherein a duration of the fourth maintenance agreement is equal to the duration of a third operating lease agreement between the lessor and the third operator, and
wherein after terminating the second operating lease agreement, and during the duration of the third operating agreement, the first maintenance agreement remains in effect between the lessor and the maintenance company.

8: The process of claim 1, which further includes;
storing maintenance data and market data in a data storage element of the computer,
identifying, in a processor of the computer, an asset management duration,
identifying, in a processor of the computer, a set of asset operational conditions,
determining, in a processor of the computer, a maintenance cost for the asset based on the asset management duration, the set of asset operational conditions, the maintenance data, the market data, and the maintenance cost,
determining, in a processor of the computer, a maintenance schedule based on one or more of the asset management duration, the set of asset operational conditions, and the maintenance data,
outputting the maintenance schedule for the asset,
generating a maintenance pricing plan for the asset maintenance over the asset management duration, and
including the maintenance schedule and maintenance pricing plan in the first maintenance agreement.

9: The process of claim 8, which further includes;
determining, on a processor of the computer, a frequency and a scope of maintenance work for the asset over the duration of the first maintenance agreement between the lessor and the maintenance company,
determining, on a processor of the computer, a cost of maintenance over the duration of the first maintenance agreement between the lessor and the maintenance company, based on the frequency and the scope of the maintenance work.

10: The process as claimed in claim 1, wherein the asset is an engine or aircraft.

11: The process as claimed in claim 1, wherein the duration of the first maintenance agreement duration between the lessor and the maintenance company is at least 15 years.

12: The process as claimed in claim 1, wherein the life of the asset is an operational life before maintenance on the asset is no longer economical.

13: A system comprising a non-transitory computer readable medium having stored thereon a program that when executed by a computer causes the computer to execute a processor-implemented process for maintaining an asset, wherein the asset is (i) owned by a lessor, (ii) maintained by a maintenance company and (iii) operated by an operator, the system including:
means for identifying, in a processor of the computer, the lessor,
means for identifying, in a processor of the computer, at least one asset in which the lessor has an ownership interest,
means for identifying, in a processor of the computer, the maintenance company which has a maintenance interest in the at least one asset, and
means for identifying, in a processor of the computer, a first operator which has a lease interest in the at least one asset,
means for initiating, in a processor of the computer, a first operating lease agreement between the lessor and the first operator, wherein the first operating lease agreement has a first operating duration, an initiation day and a termination day,
wherein no later than on a transition day after the initiation day of the first operating lease agreement, the lessor and the maintenance company enter into a first maintenance agreement,
wherein on the transition day the operator signs a second maintenance agreement with the maintenance company,
wherein between the initiation day of the first operating lease and the termination day of the first operating lease the first operator transfers funds MRF1 into a first maintenance reserve fund, and
wherein between the transition day and the termination day of the first operating lease the first operator transfers additional funds P1 into a second maintenance reserve fund.

14: A computer processor-implemented process for maintaining an asset, wherein the asset is (i) owned by a lessor, (ii) maintained by a maintenance company and (iii) operated by an operator, comprising:
identifying, in a processor of the computer, the lessor,
identifying, in a processor of the computer, at least one asset in which the lessor has an ownership interest,
identifying, in a processor of the computer, the maintenance company which has a maintenance interest in the at least one asset, and
identifying, in a processor of the computer, a first operator which has a lease interest in the at least one asset,
initiating, in a processor of the computer, a first operating lease agreement between the lessor and the first operator, wherein the first operating lease agreement has a first operating duration, an initiation day and a termination day,
wherein no later than on a transition day after the initiation day of the first operating lease agreement, the lessor and the maintenance company enter into a first maintenance agreement,
wherein on the transition day the operator signs a second maintenance agreement with the maintenance company,
wherein between the initiation day of the first operating lease and the termination day of the first operating lease the first operator transfers funds MRF1 into a first maintenance reserve fund, and
wherein between the transition day and the termination day of the first operating lease the first operator transfers additional funds P1 into a second maintenance reserve fund.
